(19) United States
(12) Patent Application Publication
(10) Pub. No.: US 2015/0307333 A1
(43) Pub. Date: Oct. 29, 2015

(54) FLOOR JACK

(71) Applicant: SpineMED Sales International Ltd., Prince George (CA)

(72) Inventor: Tim EMSKY, Prince George (CA)

(21) Appl. No.: 14/262,195

(22) Filed: Apr. 25, 2014

(51) Int. Cl. B66F 1/08; B66F 5/04

(52) U.S. Cl. CPC B66F 1/08; B66F 5/04

(57) ABSTRACT

Disclosed is a floor jack for use with a jack stand, the jack including (a) a base comprising two arms spaced apart to define a stand space between them; (b) a jack arm comprising a forked cradle comprising two spaced apart arms; and (c) a jack mechanism disposed within the base for elevating the jack pad. The base arms are configured to allow a jack stand to be positioned in the stand space, vertically aligned with the forked cradle.

### FIELD OF THE INVENTION

The present invention relates to a floor jack configured for use with a conventional jack stand.

### BACKGROUND TO THE INVENTION

It is sometimes necessary to temporarily lift a vehicle for maintenance or repair purposes, such as tire changes, suspension repair, brake repair, oil changes, and the like. Most passenger cars come with a jack for that purpose, intended primarily for emergency road-side use. Floor jacks are heavy-duty hydraulic jacks, often used in garages and service stations, and typically comprise a wheeled base, and extended handle and a jack pad which contacts and lifts the vehicle. The floor jack may be maneuvered under the vehicle using the wheeled base until correctly positioned and then actuated by pumping the handle to raise the jack pad. Due to the instability of a jacking device, it is unsafe to work on a vehicle when it is lifted only with a jacking device. Therefore, once the vehicle is elevated, jack stands are then placed under the vehicle to more stably support the vehicle.

With the advent of unibody vehicle frames, the locations and methods of elevating vehicles has become limited and specific. Most vehicles built on unibody platforms have only 4 specific lifting points on the body which are engineered to withstand the force necessary to lift or jack a vehicle up. With the limitation of 4 engineered points on a unibody vehicle, it becomes difficult if not impossible, to safely secure the jacking of a vehicle with jack stands when the jacking device is already in contact with one of the lifting points. As the currently available jacking devices utilize the entire area of the engineered lifting point surface on a unibody vehicle to elevate the unit, it becomes impossible to place and utilize a secondary safety jack stand at the same lift point. The four lift points on a unibody vehicle are most commonly placed near one of the four vehicle wheels. Lifting at one wheel elevates that specific corner of a vehicle, while the remaining three corners are left too close to the ground surface for insertion of a jack stand. This arrangement prevents the use of any of the remaining three lifting points to safely secure the vehicle with a secondary safety stand.

### SUMMARY OF THE INVENTION

The basic premise of the present invention is to utilize one specific lifting point on a unibody vehicle, or any other vehicle, structure or object, with a novel floor jack, which also allows the use of a secondary lifting or stabilization device within the same area of the lifting point. The design of the present invention allows the simultaneous placement of the jack and a secondary stabilization device within the same specific lifting area.

In general terms, the invention comprises a floor jack for use with a jack stand, the jack comprising:

(a) a base comprising two arms spaced apart to define a stand space between them;

(b) a jack arm comprising a forked cradle comprising two spaced apart arms; and

(c) a jack mechanism disposed within the base for elevating the jack pad;

wherein the base arms are configured to allow a jack stand to be positioned in the stand space, vertically aligned with the forked cradle.

In another aspect, the invention may comprise a method of lifting a vehicle using a floor jack which comprises (a) a base comprising two arms spaced apart to define a stand space between them; (b) a jack arm comprising a forked cradle having two spaced apart arms; and (c) a jack mechanism disposed within the base for elevating the jack arm and cradle; comprising the steps of:

(a) positioning the base below a vehicle lift point and actuating the jack mechanism to lift the vehicle with the forked cradle supporting the vehicle lift point;

(b) positioning a jack stand having a jack pad immediately below the vehicle lift point such that the jack pad is vertically aligned with the forked cradle and the vehicle lift point; and

(c) lowering the vehicle such that the vehicle lift point rests on the jack pad which is positioned within the forked cradle.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 shows a top-side perspective view of one embodiment of a floor jack of the present invention, in a retracted position.

FIG. 2 shows a top-side perspective of the embodiment of the floor jack of FIG. 1 in an extended position, with a jack stand positioned for use.

FIG. 3 shows a top-front perspective view of the embodiment of the floor jack of FIG. 1 in an extended position, with a jack stand positioned for use.

FIG. 4 shows a side elevation view of an alternative embodiment of a jack arm of the floor jack of the present invention.

FIG. 5 shows a top view of the embodiment of the jack arm of FIG. 4.

### DETAILED DESCRIPTION OF A PREFERRED EMBODIMENT

The present invention relates to a novel floor jack. The terms used herein have the meaning known to those skilled in the art, unless explicitly defined herein.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

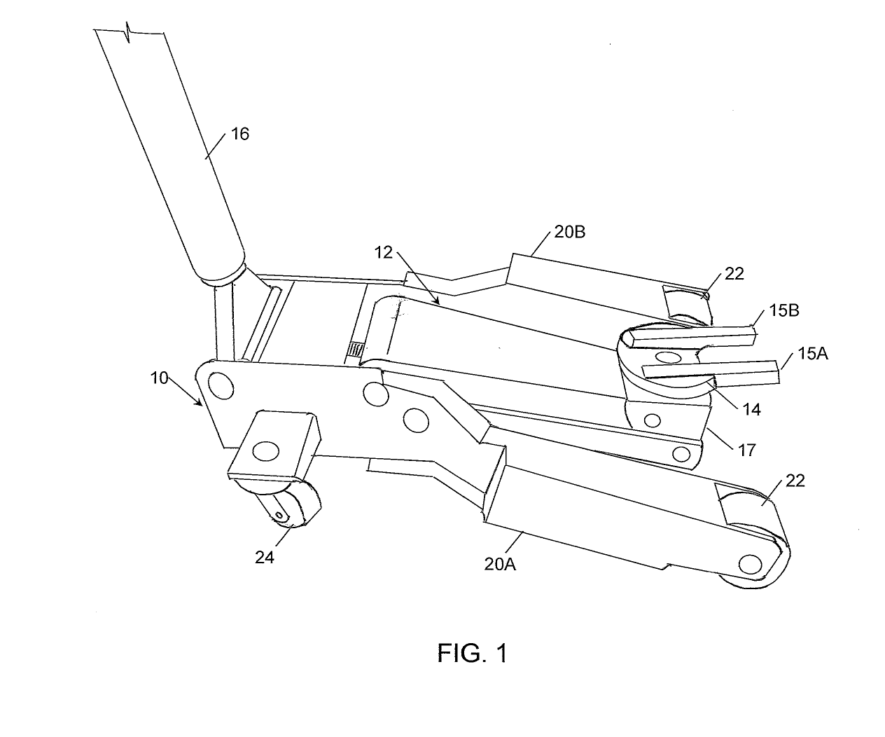

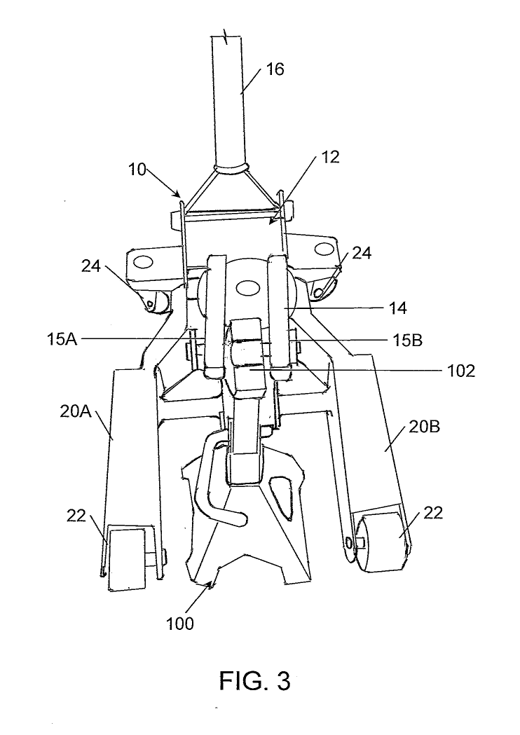

In one embodiment, as shown in FIGS. 1 to 3, the invention comprises a floor jack having a base (10), a jack arm (12) and a cradle (14) disposed on the end of the jack arm (12). The base (10) includes a hydraulic jack mechanism as is well known in the art, for lifting the jack arm. In this respect, the floor jack is configured similarly to conventional, commercially available floor jacks. A handle (16) is used to actuate the hydraulic mechanism, and to maneuver the floor jack into position underneath a vehicle.

The jack may have any mechanical, pneumatic or hydraulic lifting mechanism known in the art, which provides the mechanical advantage necessary to permit manual lifting of a load which may be as much as 3 to 6 thousand pounds. However, any configuration which uses a base (10) immediately below the lifting point will not be suitable. The present invention requires a space below the lifting point of the vehicle to be lifted to allow a jack stand to be placed under the lifting point.

In the embodiment shown in FIGS. 1 to 3, the base (10) comprises two arms (20A, 20B) which extend outwards from the main portion of the base, and define a stand space between them. The two arms are not directly connected to each other. In one embodiment, the two arms both comprise wheels (22) or casters which facilitate movement and maneuverability of the jack, and which complement wheels (24) or casters positioned on the main portion of the base (10) itself.

The jack arm (12) is configured to be positioned between the two arms (20A, 20B), when viewed in top plan or bottom plan view. The jack arm (12) ends with a cradle (14) which is intended to be the contact point with the vehicle being lifted. The cradle (14) is forked, having two spaced apart arms (15A, 15B) which define a central opening which allows the jack pad (102) of a jack stand (100) to protrude between the arms (15A, 15B).

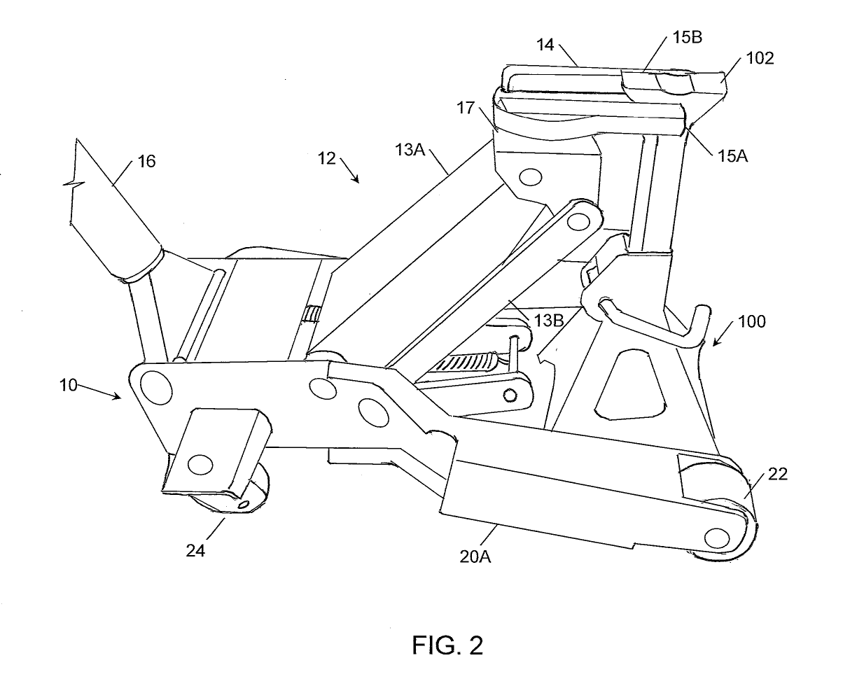

In one embodiment, as best shown in FIG. 2, the jack arm (12) includes elongate members (13A, 13B) pivotally attached to the base (10), and a mounting member (17) pivotally attached to the top of the elongate members (13A, 13B). When viewed from above, the cradle (14) has a U-shaped configuration, with the spaced apart arms (15A, 15B) extending away from the base of the U-shape. When viewed from above, the mounting member (17) has a rectangular configuration. The base of the U-shaped cradle (14) is secured to the mounting plate (15) such that the spaced apart arms (15A, 15B) cantilever away from the front edge of the mounting member (17).

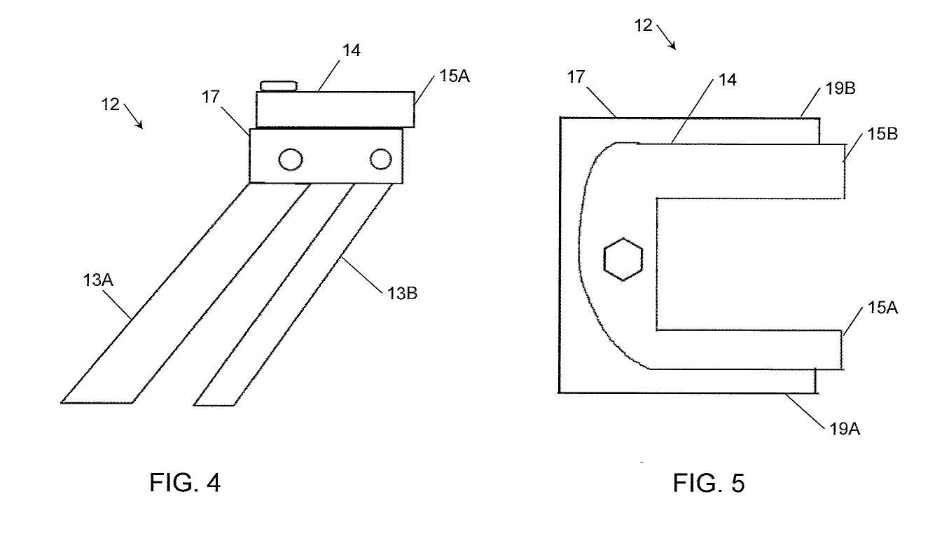

FIGS. 4 and 5 show an alternative embodiment of the jack arm (12) that differs in that the mounting member (17) is also U-shaped. The mounting member (17) has two spaced apart arms (19A, 19B) with their terminal ends pivotally attached to the elongate member (13B). The spaced apart arms (19A, 19B) support the spaced apart arms (15A, 15B) of the cradle (14) along the substantial entirety of their length. Compared to the embodiment shown in FIGS. 1 to 3, this embodiment of the jack arm (12) allows the geometric center of the base (10) to be positioned closer to the lifting point of the vehicle, so that the vehicle's weight is more evenly distributed between the wheels (22) and the wheels (24) when the vehicle is supported by the floor jack.

When the jack arm (12) is in an extended position as shown in FIG. 2, no part of the arm (12) except for the cradle (14) is disposed immediately below the lifting point of the vehicle.

In use, the jack is positioned such that the cradle (14) is immediately below the jacking point of the vehicle, and is actuated with the handle (16) in a conventional manner to lift the vehicle. When lifted to a desired degree, a conventional jack stand (100) may then positioned within the stand space between the two base arms (20A, 20B) simply by sliding the jack stand (100) into place in vertical alignment with the forked cradle (14), such that the jack pad (102) is positioned between the spaced apart arms (15A, 15B). The jack pad (102) may then be extended to pass between the spaced apart arms (15A, 15B) of the cradle (14) and almost into contact with the lifting point of the vehicle.

The jack may then be retracted as shown in FIG. 1, thus lowering the vehicle onto the jack pad (102) of jack stand (100). The jack may then be removed, leaving the vehicle supported by the jack stand (100) on the same jacking point that was used to lift the vehicle.

What is claimed is:

1. A floor jack for use with a jack stand, the jack comprising:
(a) a base comprising two arms spaced apart to define a stand space between them;
(b) a jack arm comprising a forked cradle having two spaced apart arms; and
(c) a jack mechanism disposed within the base for elevating the jack arm and cradle;
wherein the base arms are configured to allow the jack stand to be positioned in the stand space, vertically aligned with the forked cradle.

2. The jack of claim 1 wherein each base arm comprises a wheel or caster.

3. The jack of claim 1 wherein the jack mechanism comprises a hydraulic lifting mechanism.

4. The jack of claim 1 wherein the cradle is U-shaped.

5. The jack of claim 1 wherein the jack arm comprises a mounting member which supports the forked cradle.

6. The jack of claim 5 wherein the forked cradle is mounted directly over the mounting member and both are U-shaped.

7. The jack of claim 5 wherein the forked cradle is cantilevered from the mounting member.

8. A method of lifting a vehicle using a floor jack which comprises (a) a base comprising two arms spaced apart to define a stand space between them; (b) a jack arm comprising a forked cradle having two spaced apart arms; and (c) a jack mechanism disposed within the base for elevating the jack arm and cradle; comprising the steps of:
(a) positioning the base below a vehicle lift point and actuating the jack mechanism to lift the vehicle with the forked cradle supporting the vehicle lift point;
(b) positioning a jack stand having a jack pad immediately below the vehicle lift point such that the jack pad is vertically aligned with the forked cradle and the vehicle lift point; and
(c) lowering the vehicle such that the vehicle lift point rests on the jack pad which is positioned within the forked cradle.
